(19) United States
(12) Patent Application Publication
(10) Pub. No.: US 2026/0018944 A1
(43) Pub. Date: Jan. 15, 2026

(54) STATOR ASSEMBLY AND MANUFACTURING METHOD THEREFOR, AND MOTOR

(71) Applicant: ZHEJIANG SANHUA INTELLIGENT CONTROLS CO., LTD., Shaoxing (CN)

(72) Inventors: Yangjun ZHAO, Shaoxing (CN); Jiangjun ZHU, Shaoxing (CN)

(73) Assignee: ZHEJIANG SANHUA INTELLIGENT CONTROLS CO., LTD., Shaoxing (CN)

(21) Appl. No.: 19/332,171

(22) Filed: Sep. 18, 2025

Related U.S. Application Data
(63) Continuation of application No. PCT/CN2024/082862, filed on Mar. 21, 2024.

(30) Foreign Application Priority Data
Mar. 23, 2023 (CN) 202310316794.1

(51) Int. Cl. H02K 1/14; H02K 3/34; H02K 3/50; H02K 15/022; H02K 15/095; H02K 15/106; H02K 15/121; H02K 15/32

(52) U.S. Cl. CPC H02K 1/146; H02K 3/345; H02K 3/50; H02K 15/022; H02K 15/095; H02K 15/106; H02K 15/121; H02K 15/32; H02K 2203/03

(57) ABSTRACT

A stator assembly, a motor, and a manufacturing method for the stator assembly are disclosed. The stator assembly includes a stator and a main control board arranged at an axial outer end of the stator. The stator is spliced together by a plurality of stator cores. A stator winding is wound around the stator core. The stator winding has a wring terminal. The main control board has at least two spaced-apart connection slots. At least a portion of an inner circumferential wall of the connection slot is provided with a first conductive portion. Each wiring terminal is disposed in a corresponding connection slot and electrically connected to the first conductive portion. The winding connection structure provides a simple process and is easy to install.

### CROSS-REFERENCE TO RELATED APPLICATIONS

This application is a continuation of International Application No. PCT/CN 2024/082862, filed Mar. 21, 2024, which claims priority to Chinese Patent Application No. 202310316794.1, filed Mar. 23, 2023. The contents of all these patent applications are incorporated herein by reference in their entireties.

### TECHNICAL FIELD

The present invention relates to the technical field of motors, and in particular to a stator assembly, a motor, and a method for manufacturing the stator assembly.

### BACKGROUND

An existing wiring method for a motor stator winding is to first fix lead wires of stator windings using one or more busbars, and then weld the lead wires. The busbars are then injection-molded into an insulating plastic, and the lead wires of the stator windings are connected via the busbars. The busbars and the lead wires of the stator windings are then crimped together and resistance-welded. The busbars are then encased in a plastic insulating bracket. This wire connection method suffers from complex processing and high costs. Specifically, the use of bracket and busbars to connect the windings, coupled with multiple crimping, welding and injection molding processes, results in complex processing steps and high material costs.

### SUMMARY

To address the above deficiencies or shortcomings, the present disclosure provides a stator assembly with stator windings configured to simplify the current connection structure of the wiring terminals of the stator windings.

To achieve the above objectives, the present disclosure provides a stator assembly as follows:
a stator assembly including: a stator and a main control board disposed at an axial outer end of the stator, the stator including a plurality of stator cores, the stator cores being wound with stator windings, the stator windings including wiring terminals; wherein the main control board defines at least two connection slots that are spaced apart; at least a portion of an inner peripheral wall of each connection slot is provided with a first conductive portion; each wiring terminal is disposed in a connection slot; and the wiring terminal is electrically connected to the first conductive portion.

The connection mechanism implemented by the stator windings of the stator assembly is easy to install, and the connection structure of the wiring terminal of the stator winding is simplified.

The present disclosure also provides a method for manufacturing a stator assembly, including:
performing insert molding on a single stator core to form a stator core with an insulating frame; winding a stator winding onto the stator core with the insulating frame, and forming a wiring terminal for each stator winding; splicing the single stator core wound with the stator winding along a circumferential direction to form a stator; mounting a main control board with connection slots at an axial outer end of the stator, and mounting the wiring terminals in the connection slots in a one-to-one correspondence manner; and electrically connecting the wiring terminal to a first conductive portion on an inner wall of the connection slot by welding.

The stator assembly manufactured by the above-mentioned manufacturing method of the stator assembly has a simple connection structure of the stator winding, and is easy to install.

The present disclosure also provides a motor, the motor including: a stator assembly, a rotor assembly and a shell, the stator assembly being disposed in the shell, the stator assembly including a stator and a main control board disposed at an axial outer end of the stator, the stator including a plurality of stator cores, the stator cores being wound with stator windings, the stator windings including wiring terminals; wherein the main control board has at least two connection slots which are spaced apart; at least a portion of an inner wall of each connection slot is provided with a first conductive portion; and each wiring terminal is disposed in a connection slot, and the wiring terminal is electrically connected to the first conductive portion.

The connection structure of the stator winding of the above motor is simple and easy to install, which can improve the production efficiency of the motor.

### BRIEF DESCRIPTION OF DRAWINGS

FIG. 1 shows a perspective view of an exemplary stator assembly in an existing technology;

FIG. 2 shows a perspective view of an exemplary stator assembly in accordance with a first embodiment thereof;

FIG. 3 shows an exploded view of the stator assembly shown in FIG. 2;

FIG. 4 shows a perspective view of an exemplary stator core;

FIG. 5 shows a front view of the exemplary stator assembly in accordance with a second embodiment thereof;

FIG. 6 shows a front view of an exemplary main control board in accordance with the second embodiment thereof;

FIG. 7 shows a perspective view of one example of the connection methods of stator windings in accordance with the second embodiment thereof;

FIG. 8 shows a front view of wiring terminals installed on the exemplary main control board in accordance with the second embodiment thereof; and

FIG. 9 shows an exploded view of an exemplary motor.

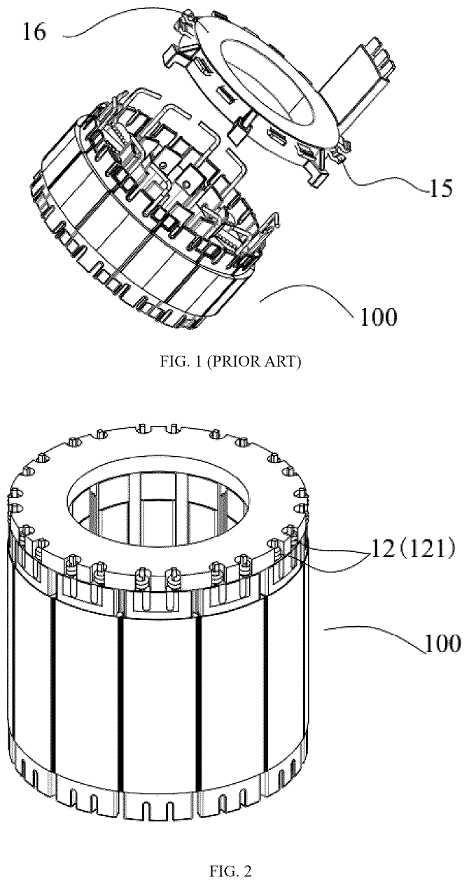

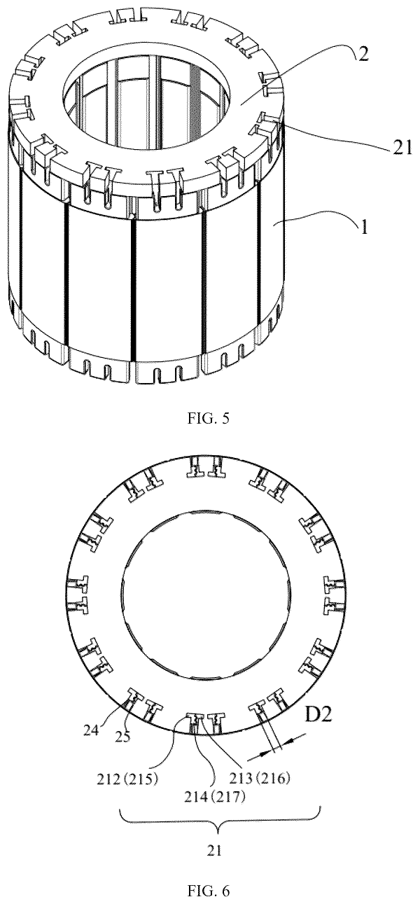

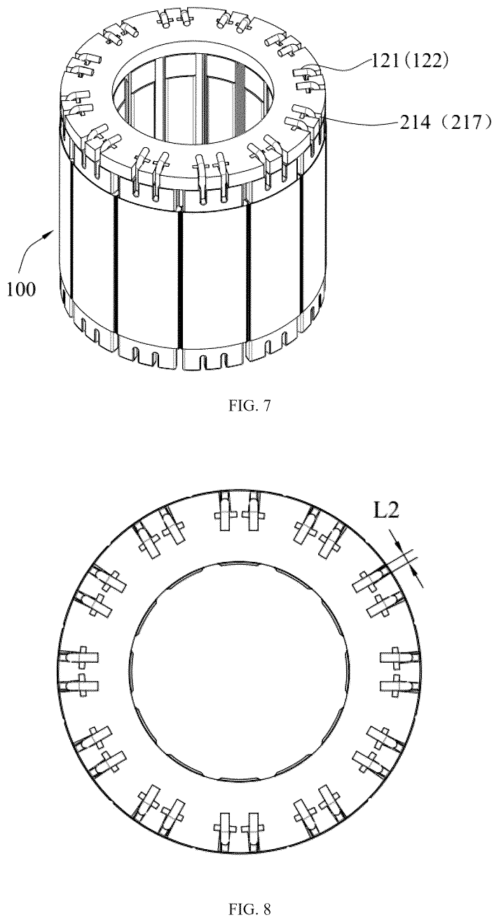

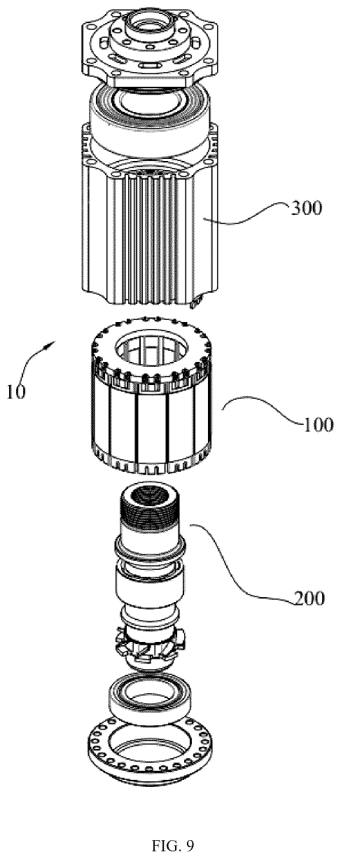

The correspondence between the legends and component names in FIG. 1 to FIG. 9 is as follows:
100, stator assembly; 1, stator; 2, main control board; 11, stator core; 12, stator winding; 121, wiring terminal; 21, connection slot; 211, first conductive portion; 13, pin; 14, insulating frame; 122, second conductive portion; 122′, second conductive portion; 131, third conductive portion; 212, first slot section; 213, second slot section; 214, third slot section; 215, fourth conductive portion; 216, fifth conductive portion; 217, sixth conductive portion; 200, rotor assembly; 15, bus bar; 16, insulating bracket; 10, motor; 300, shell; 22, first wall; 23, second wall; 24, third wall; 25, fourth wall.

### DETAILED DESCRIPTION

In order to clearly describe the above-mentioned objects, features and advantages of the present disclosure are further described in detail below in conjunction with the accompanying drawings and specific embodiments. It should be noted that, in the absence of conflict, the embodiments of the present application and the features therein can be combined with each other.

While various embodiments are described below, it is contemplated that the disclosed features may also be implemented in other ways than those described herein. Therefore, the scope of protection of the present invention is not limited by the specific embodiments disclosed below.

An existing method for connecting stator windings of a motor is to use one or more busbars 15 to first fix lead wires of stator windings, and then weld the lead wires. Then, the busbars 15 are injection-molded into an insulating plastic. As shown in FIG. 1, wiring terminals 121 of the stator windings 12 of the motor are connected to the busbars 15. The busbars 15 and the wiring terminals 121 are crimped before being resistance-welded. Then, the busbars 15 are encapsulated in an insulating bracket 16. This connection method has the problems of complex process and high cost. In particular, due to the use of the insulating bracket 16 and the busbars 15 to connect the stator windings 12, and the use of multiple crimping, welding and injection molding processes, there are problems such as complex processing procedures and high material costs.

In order to solve the problems in the above-mentioned existing technology, the present disclosure provides a stator assembly 100, as shown in FIG. 2.

In some implementations, the stator assembly 100 includes a stator 1 and a main control board 2 disposed at an axial outer end of the stator 1. In some implementations, the stator 1 is spliced together by a plurality of stator cores 11. A stator winding 12 is wound around each stator core 11. The stator winding 12 includes a wiring terminal 121. In some implementations, the main control board 2 defines at least two connection slots 21 that are spaced from each other. In some implementations, at least part of an inner circumferential wall of each connection slot 21 is provided with a first conductive portion 211. The wiring terminals 121 are disposed in corresponding connection slots 21. For example, each wiring terminal 121 is electrically connected to a first conductive portion 211, resulting in the conduction of the stator winding 12 and forming a circuit on the main control board 2. The electrical connection can be achieved by welding. In some implementations, the welding method can be soldering or laser welding. By using the electrical connection between the wiring terminal 121 of the stator winding 12 and the first conductive portion 211 in the connection slot 21 no insulating bracket or a busbar is necessary to connect the stator winding. Accordingly, the connection structure of the wiring terminal of the stator winding is simplified. In some implementations, each stator core 11 is wound with the stator winding 12. In some implementations, each of the stator windings 12 includes two wiring terminals 121, which are electrically connected to the corresponding connection slots 21, respectively. An outer periphery of the main control board 2 defines the at least two connection slots 21 that are spaced apart along a circumference of the main control board 2. In some implementations, the connection slots 21 are opened outward along a radial direction of the main control board 2, and are disposed in a one-to-one correspondence manner with the wiring terminals 121.

Furthermore, in practical applications, the motor winding ends have to meet particular requirements for wiring, e.g., the wire diameter of the stator winding used in some low-power motors is relatively thin, and is easily broken by pulling. Moreover, it can be challenging to arrange the wiring terminal 121 of the stator winding 12 inside the connection slot 21, and it is not convenient to weld it to the first conductive portion 211 on an inner wall of the connection slot 21 to achieve electrical connection. In some implementations, in order to support and stabilize the wiring terminal 121 of the stator winding 12, the stator 1 can also be provided with a plurality of pins 13. In some implementations, the material of the pin 13 can be metal or an insulating material. As viewed from an end direction of the stator 1, the pins 13 are disposed at equal distances in the circumferential direction. In some implementations, the stator 1 further includes an insulating frame 14. In some implementations, the insulating frame 14 is sleeved on an axial outer end of the stator core 11. One end of the pin 13 is inserted into the insulating frame 14, and another end of the pin 13 is recessed and disposed in the connection slot 21. In some implementations, the wiring terminal 121 is disposed in the connection slot 21, and wraps around at least a portion of an outer side of the pin 13. Concavely positioning the pin 13 in the connection slot 21 may help reduce the height of the stator assembly 100, further shortening the axial size of the motor, and ensuring the small size and lightness of the motor 10.

In some implementations, the material of the pin 13 in the present application can be a metal material with good electrical conductivity, such as copper or aluminum; or an insulating material, such as plastic. As a metal pin is stronger than an insulating pin, it can more stably support the wiring terminal 121 of the stator winding 12, and is more conducive to improve welding strength and electrical connection reliability during the welding process. In some implementations, when the pin 13 is made of metal, the wiring terminal 121 is provided with a second conductive portion 122, and the pin 13 is provided with a third conductive portion 131. The first conductive portion 211, the second conductive portion 122 and the third conductive portion 131 are electrically connected by welding. In some alternative implementations, when the pin 13 is made of insulating material, the pin 13 only serves to support and stabilize the wiring terminal 121 and does not contribute to the electrical connection. In this case, the wiring terminal 121 is provided with a second conductive portion 122′. The first conductive portion 211 and the second conductive portion 122′ are electrically connected by welding.

In some implementations, the main control board 2 includes a first wall 22 and a second wall 23. In some implementations, the first wall 22 and the second wall 23 are disposed opposite to each other. The connection slot 21 is located between the first wall 22 and the second wall 23. Accordingly, the maximum distance between the first wall 22 and second wall 23 is greater than the maximum outer diameter of the wiring terminal 121. For example, along a radial direction of the stator assembly, a maximum distance between the first wall 22 and the second wall 23 is D1, and the wiring terminal 121 is columnar with a maximum outer diameter of the wiring terminal 121 being L1, then D1 is greater than L1. In some implementations, the wiring terminal 121 is shorter than connection slot 21. For example, along an axial direction of the stator assembly, the wiring terminal 121 extends for a length H1 and the connection slot 21 extends for a length H2, then H1 is less than H2.

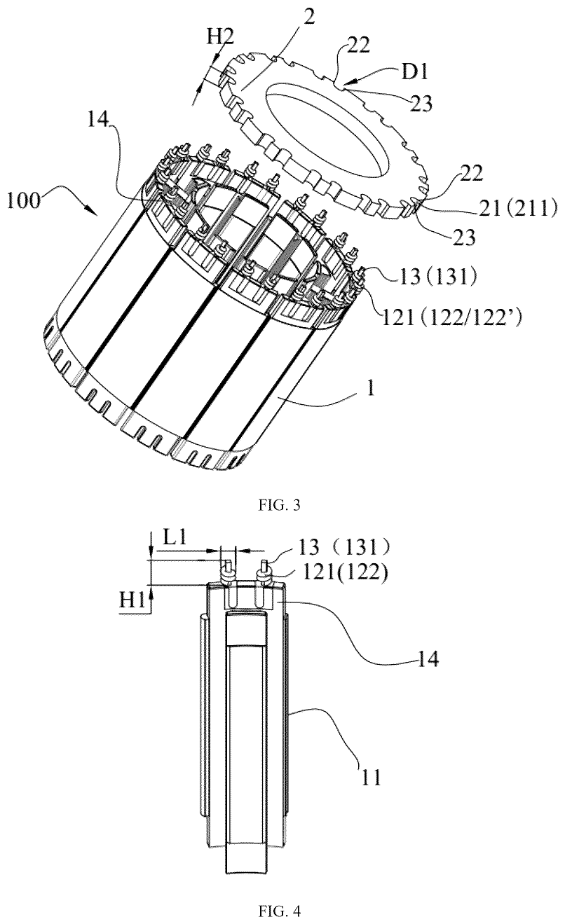

As shown in FIG. 3 and FIG. 4, the main control board 2 includes a first wall 22 and a second wall 23. The first wall 22 and the second wall 23 are disposed opposite to each other in the radial direction of the stator assembly. The first wall 23 and the second wall 23 form the connection slot 21. In some implementations, the radial direction of the stator assembly, the maximum distance between the first wall 22 and the second wall 23 is D1. That is, the maximum radial width of the connection slot 21 is D1. The wiring terminal 121 is columnar, and the maximum outer diameter of the columnar wiring terminal 121 is L1. That is, the maximum radial width of the wiring terminal 121 is L1. The maximum radial width D1 of the connection slot 21 is greater than the maximum radial width L1 of the wiring terminal 121. This ensures that when the wiring terminal 121 is disposed within the connection slot 21, a gap exists between an exterior of the wiring terminal 121 and the walls of the connection slot 21. This facilitates penetration of tin into the connection slot 21 when the wiring terminal 121 is welded to the first conductive portion 211 in the connection slot 21, ensuring welding strength. In some implementations, along the axial direction of the stator assembly, the extended length H1 of the wiring terminal 121 is the height of the wiring terminal 121, and the extended length H2 of the connection slot 21 is the height of the connection slot 21. The height H1 of the wiring terminal 121 is less than the height H2 of the connection slot 21. This allows the wiring terminal 121 to be completely concealed within the connection slot 21 when located therein, preventing interference with other axially located components and preventing the occurrence of excessively short creepage distances. For stator windings 12 with larger wire diameters, winding machines are unable to wrap the winding copper wires around the pins 13, and manual operation is also impossible. Consequently, motors using large-diameter windings cannot use the main control board 2. Furthermore, to ensure connection reliability, the stator winding 12 typically requires at least three wraps around the pins 13. This results in a greater axial distance between the main control board 2 and an end surface of the stator core 11, increasing the overall length of the motor. This solution also requires additional material for the pins 13, which in turn increases labor costs. Therefore, in the stator assembly 100 in the disclosed embodiments, the pins 13 do not need to be used to support and stabilize the wiring terminal 121, and the structure of the connection slot 21 of the main control board 2 can also support and clamp the wiring terminal 121.

Specifically, in some implementations, the connection slot 21 includes a first slot section 212, a second slot section 213, and a third slot section 214. A fourth conductive portion 215 is provided on at least a portion of an inner wall of the first slot section 212. A fifth conductive portion 216 is provided on at least a portion of an inner wall of the second slot section 213. A sixth conductive portion 217 is provided on at least a portion of an inner wall of the third slot section 214.

In some implementations, the wiring terminal 121 is electrically connected to at least one of the fourth conductive portion 215, the fifth conductive portion 216, and the sixth conductive portion 217 to achieve electrical connection between the stator winding 12 and the main control board 2. In some implementations, the wiring terminal 121 is first inserted into the first slot section 212, or the second slot section 213, or the third slot section 214 using a tool, and then the wiring terminal 121 is welded to the first slot section 212, or the wiring terminal 121 is welded to the second slot section 213, or the wiring terminal 121 is welded to the third slot section 214. For example, laser welding or soldering can be used, and the soldering process can be dip soldering. Alternatively, the wiring terminal 121 can be inserted into the first slot section 212, or the second slot section 213, or the third slot section 214, and no welding is applied. An interference fit between the wiring terminal 121 and the first slot section 212, or the second slot section 213, or the third slot section 214 may be sufficient, although the welding connection method is more reliable.

In some implementations, the third slot section 214 extends along the axial direction of the stator assembly. Along the radial direction of the stator assembly, the first slot section 212 and the second slot section 213 extend in opposite directions, respectively. The first slot section 212, the second slot section 213 and the third slot section 214 are interconnected. The main control board 2 includes a third wall 24 and a fourth wall 25. The third wall 24 and the fourth wall 25 are disposed opposite to each other. The third slot section 214 is located between the third wall 24 and the fourth wall 25. Along the radial direction of the stator assembly, a maximum distance between the third wall 24 and the fourth wall 25 is D2. The wiring terminal 121 is columnar, and a maximum outer diameter of the wiring terminal 121 is L2, where D2 is less than or equal to L2.

As shown in FIG. 5 to FIG. 8, in some implementations, the first slot section 212 and the second slot section 213 extend radially along the stator assembly. The third slot section 214 extends axially along the stator assembly. The first slot section 212, the second slot section 213, and the third slot section 214 are arranged in a T-shape. In some implementations, the main control board 2 includes a third wall 24 and a fourth wall 25 disposed opposite to each other. The third slot section 214 is located between the third wall 24 and the fourth wall 25. The third wall 24 and the fourth wall 25 form the walls of the third slot section 214. In the radial direction of the stator assembly, the maximum distance between the third wall 24 and the fourth wall 25 is D2, meaning that the maximum radial width of the third slot section 214 is D2. The wiring terminal 121 is columnar. The maximum outer diameter of the columnar wiring terminal 121 is L2, meaning that the maximum radial width of the wiring terminal 121 is L2. The maximum radial width D2 of the third slot section 214 needs to be less than or equal to the maximum radial width L2 of the wiring terminal 121. In this way, the wiring terminal 121 snaps into the third slot section 214, and creating an interference fit between the wiring terminal 121 and the third slot section 214. The radially extending first and second slot sections 212 and 213 provide space for the tin to drip. Furthermore, the interconnected arrangement of the first slot section 212, the second slot section 213, and the third slot section 214 ensures that the wiring terminal 121 in the third slot section 214 fuses with the conductive portion and tin within the connection slot 21, further enhancing the welding strength between the wiring terminal and the main control board.

The present disclosure further provides a manufacturing method of a stator assembly 100 in accordance with a first embodiment, including:
performing insert molding on a single stator core 11 to form a stator core 11 with an insulating frame 14;
winding a stator winding 12 onto the stator core 11 with the insulating frame 14, and forming two wiring terminals 121 for each stator winding 12;
splicing the single stator core 11 wound with the stator winding 12 along a circumferential direction to form a stator 1;
mounting a main control board 2 with connection slots 21 at an axial outer end of the stator 1, and mounting the wiring terminals 121 in the connection slots 21 in a one-to-one correspondence manner; and
electrically connecting the wiring terminal 121 to a first conductive portion 211 on an inner wall of the connection slot 21.

The manufacturing method of the stator assembly in this embodiment can be used for stator windings 12 of various wire diameters. The wiring terminal 121 can be placed inside the connection slot 21 manually.

The present disclosure also provides a manufacturing method for a stator assembly 100 in accordance with a second embodiment, including:
performing insert molding on a single stator core 11 and a plurality of pins 13 together to form a stator core 11 with an insulating frame 14;
winding a stator winding 12 onto the stator core 11 with the insulating frame 14, and forming two wiring terminals 121 for each stator winding 12; and winding the wiring terminal 121 around an outside of the pin 13;
splicing the single stator core 11 wound with the stator winding 12 along a circumferential direction of the stator assembly 100 to form a stator 1;
mounting a main control board 2 with connection slots 21 at an axial outer end of the stator 1, and mounting the wiring terminals 121 in the connection slots 21 in a one-to-one correspondence manner; and
electrically connecting a second conductive portion 122 of the wiring terminal 121, a first conductive portion 211 of an inner wall of the connection slot 21, and a third conductive portion 131 of the pin 13; or electrically connecting a second conductive portion 122′ of the wiring terminal 121 to the first conductive portion 211 of the inner wall of the connection slot 21.

In some implementations, he manufacturing method for the stator assembly in this embodiment can be used in motors with relatively small stator winding wire diameters, where the pins 13 can play a role in supporting and stabilizing the stator windings to a certain extent.

The stator assembly manufactured by the above-mentioned manufacturing method for the stator assembly has a simple connection structure of the stator winding and is easy to install.

The present disclosure further provides a motor 10 including the stator assembly 100 according to any of the above designs. Thus, the motor 10 possesses all the benefits of the stator assembly. Specifically, the connection structure of the stator winding is simple and easy to install, which can significantly improve the production efficiency of the motor 10.

In some implementations, the motor 10 further includes a shell 300 and a rotor assembly 200. The stator assembly 100 is disposed in the shell 300. The stator assembly 100 includes the stator 1 and the main control board 2 arranged at the axial outer end of the stator 1. In some implementations, the stator 1 is spliced together by the plurality of stator cores 11. The stator winding 12 is wound around each stator core 11. The stator winding 12 has a wiring terminal 121. The main control board 2 defines the plurality of connection slots 21 that are spaced apart. In some implementations, at least part of the inner circumferential wall of each connection slot 21 is provided with the first conductive portion 211. In some implementations, the wiring terminal 121 is located in the connection slot 21. In some implementations, the wiring terminal 121 is electrically connected to the first conductive portion 211, resulting in the conduction of the stator winding 12 and forming the circuit on the main control board 2.

In the present disclosure, the term “plurality of” refers to two or more, unless otherwise specified. Terms such as “mounting”, “connecting”, “connection” and “fixing” should be interpreted broadly, for example, the term “connection” can be a fixed connection, a detachable connection, or an integral connection; and the term “connecting” can be directly connecting or indirectly connecting through an intermediary. It is understandable to those skilled in the art that the specific meanings of the above terms in the present disclosure based on the specific circumstances.

The foregoing description is merely a preferred embodiment of the present invention and is not intended to limit the present invention. Those skilled in the art will readily appreciate that various modifications and variations of the present invention are possible. Any modifications, equivalent substitutions, or improvements made within the spirit and principles of the present application, which is defined by the claims.

What is claimed:

1. A stator assembly, comprising:
a stator comprising a plurality of stator cores, the stator cores being wound with stator windings, the stator windings comprising wiring terminals; and
a main control board disposed at an axial outer end of the stator,
wherein the main control board defines at least two connection slots that are spaced apart, at least a portion of an inner peripheral wall of each connection slot is provided with a first conductive portion, each wiring terminal is disposed in a corresponding connection slot and electrically connected to the first conductive portion.

2. The stator assembly according to claim 1, wherein an outer periphery of the main control board defines the at least two connection slots that are spaced apart along a circumferential direction of the main control board; and the connection slots are opened outward along a radial direction of the main control board, and are disposed in a one-to-one correspondence manner with the wiring terminals.

3. The stator assembly according to claim 2, wherein the stator further comprises a plurality of pins and an insulating frame,
wherein a material of the pin is metal or insulating material; the insulating frame is sleeved over an axial outer end of the stator core; one end of the pin is inserted into the insulating frame, and another end of the pin is recessed and disposed in the connection slot; the wiring terminal is located within the connection slot, and the wiring terminal is wound around at least a portion of an outer side of the pin.

4. The stator assembly according to claim 3, wherein the material of the pin is a metal material; the wiring terminal is provided with a second conductive portion; the pin is provided with a third conductive portion; and the first conductive portion, the second conductive portion and the third conductive portion are electrically connected to one another.

5. The stator assembly according to claim 3, wherein the material of the pin is an insulating material; the wiring terminal is provided with a second conductive portion; and the first conductive portion and the second conductive portion are electrically connected with each other.

6. The stator assembly according to claim 1, wherein the main control board comprises a first wall and a second wall disposed opposite to each other, and the connection slot is located between the first wall and the second wall,
wherein a farthest distance between the first wall and the second wall along a radial direction of the stator assembly is greater than a maximum outer diameter of the wiring terminal.

7. The stator assembly according to claim 6, wherein along an axial direction of the stator assembly, an extension length of the wiring terminal is less than or equal to an extension length of the connection slot.

8. The stator assembly according to claim 1, wherein the connection slot comprises a first slot section, a second slot section and a third slot section,
wherein at least a portion of an inner wall of the first slot section is provided with a fourth conductive portion, at least a portion of an inner wall of the second slot section is provided with a fifth conductive portion, and at least a portion of an inner wall of the third slot section is provided with a sixth conductive portion,
wherein the wiring terminal is electrically connected to at least one of the fourth conductive portion, the fifth conductive portion or the sixth conductive portion.

9. The stator assembly according to claim 8, wherein the third slot section extends along an axial direction of the stator assembly; the first slot section and the second slot section extend in opposite directions respectively along a radial direction of the stator assembly; and the first slot section, the second slot section and the third slot section are interconnected.

10. The stator assembly according to claim 9, wherein the main control board comprises a third wall and a fourth wall disposed opposite to each other, and the third slot section is located between the third wall and the fourth wall,
wherein along the radial direction of the stator assembly, a farthest distance between the third wall and the fourth wall is less than or equal to a maximum outer diameter of the wiring terminal.

11. The stator assembly according to claim 1, wherein each stator core is wound with the stator winding, and each stator winding has two wiring terminals electrically connected to corresponding connection slots, respectively.

12. The stator assembly according to claim 7, wherein the wiring terminal and the first conductive portion are electrically connected by soldering or laser welding.

13. A manufacturing method for making a stator assembly, comprising:
performing insert molding on a single stator core to form a stator core with an insulating frame;
winding a stator winding onto the stator core with the insulating frame, and forming a wiring terminal for each stator winding;
splicing the single stator core wound with the stator winding along a circumferential direction to form a stator;
mounting a main control board with connection slots at an axial outer end of the stator, and mounting the wiring terminals in the connection slots in a one-to-one correspondence manner; and
electrically connecting the wiring terminal to a first conductive portion on an inner wall of the connection slot by welding.

14. An electric motor, comprising:
a shell;
a rotor assembly; and
a stator assembly disposed in the shell, the stator assembly comprising a stator and a main control board disposed at an axial outer end of the stator, the stator comprising a plurality of stator cores, the stator cores being wound with stator windings, the stator windings comprising wiring terminals, wherein the main control board has at least two connection slots that are spaced apart, at least a portion of an inner wall of each connection slot is provided with a first conductive portion, and each wiring terminal is disposed in a corresponding connection slot and electrically connected to the first conductive portion.

15. The electric motor according to claim 14, wherein the main control board comprises a first wall and a second wall disposed opposite to each other, the first wall and a second wall extending along a thickness direction of the main control board, and the connection slot located between the first wall and the second wall,
wherein a distance between the first wall and the second wall is greater than an outer diameter of the wiring terminal.

16. The electric motor according to claim 14, wherein along an axial direction of the stator assembly, an extension length of the wiring terminal is less than an extension length of the connection slot.

17. The electric motor according to claim 14, wherein the wiring terminal and the first conductive portion are physically connected by soldering or laser welding, and the wiring terminal and the first conductive portion are electrically connected.

18. The electric motor according to claim 14, wherein an outer periphery of the main control board defines the at least two connection slots that are spaced apart along a circumferential direction of the main control board; the connection slots being opened outward along a radial direction of the main control board, and the connection slots being disposed in a one-to-one correspondence manner with the wiring terminals.

19. The electric motor according to claim 14, wherein each stator core is wound with the stator winding, and each stator winding has two wiring terminals electrically connected to corresponding connection slots, respectively.

20. The electric motor according to claim 15, wherein the main control board comprises a third wall and a fourth wall disposed opposite to each other, and the third slot section is located between the third wall and the fourth wall,
wherein a distance between the third wall and the fourth wall is less than or equal to an outer diameter of the wiring terminal.
